(19) United States
(12) Patent Application Publication
(10) Pub. No.: US 2008/0220728 A1
(43) Pub. Date: Sep. 11, 2008

(54) PTT-ENABLED MOBILE TERMINAL, PTT SERVICE PROVIDING SYSTEM, AND SENDER LOCATION DISPLAY METHOD

(75) Inventor: Sang Uk SEO, Daegu Metropolitan City (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/776,179

(22) Filed: Jul. 11, 2007

(30) Foreign Application Priority Data
Mar. 6, 2007 (KR) 10-2007-0021983

(51) Int. Cl. H04B 1/38

(52) U.S. Cl. 455/90.2

(57) ABSTRACT

A Push-To-Talk (PTT) enabled mobile terminal, PTT service providing system, and sender location display method are disclosed. The sender location display method includes transmitting current location information of a calling PTT-enabled mobile terminal to a Session Initiation Protocol (SIP) server at initiation of a PTT call by a calling PTT-enabled mobile terminal, forwarding the location information from the calling PTT-enabled mobile terminal to a called PTT-enabled mobile terminal by the SIP server, and outputting the location information from the SIP server by the called PTT-enabled mobile terminal.

### CROSS REFERENCE TO RELATED APPLICATION

This application claims priority from and the benefit of Korean Patent Application No. 10-2007-0021983, filed on Mar. 6, 2007, which is hereby incorporated by reference for all purposes as if fully set forth herein.

### BACKGROUND OF THE INVENTION

1. Field of the Invention

The present invention relates to mobile communication and, more particularly, to a Push-To-Talk (PTT) enabled mobile terminal, a PTT-service providing system, and a sender location display method that may enable a called PTT-enabled mobile terminal to display the location of the calling PTT-enabled mobile terminal in PTT communication.

2. Discussion of the Background

Push-to-Talk (PTT) refers to walkie-talkie style communication, in which a PTT key is pressed to enter a voice transmission mode and released to enter a voice reception mode. Recently, PTT communication services have been provided to PTT-enabled mobile terminals having an Internet Protocol (IP) address for one-to-one or one-to-many communication using Voice over IP (VoIP) technology.

To use a PTT service, the calling user presses the PTT key of a calling PTT-enabled mobile terminal and places a PTT call to a called PTT-enabled mobile terminal. The called PTT-enabled mobile terminal receives the PTT call, alerts the called user to the incoming PTT call using alarm sounds, and displays PTT call information, such as the call number of the calling PTT-enabled mobile terminal, the name of the calling user, and an associated image, on a screen. The called user hears the alarm sounds and accepts the incoming PTT call. Thereby, a PTT conversation is initiated between the calling user and called user.

In a PTT communication service, a PTT group call is an effective means for serving a group of members. For more effective group activities, locations of the group members may be necessary. However, a conventional PTT-service providing system may fail to provide a location service. Hence, to identify the location of the other user, one user may have to directly ask the location of the other user during PTT conversation.

### SUMMARY OF THE INVENTION

The present invention provides a PTT-enabled mobile terminal, a PTT-service providing system, and a sender location display method that may enable a called PTT-enabled mobile terminal to display the location of the calling PTT-enabled mobile terminal in real-time during PTT communication for user convenience.

Additional features of the invention will be set forth in the description which follows, and in part will be apparent from the description, or may be learned by practice of the invention.

The present invention discloses a sender location display method for a Push-To-Talk (PTT) service providing system, including transmitting current location information of a PTT enabled mobile terminal to a Session Initiation Protocol (SIP) server at initiation of a PTT call by calling the PTT enabled mobile terminal, forwarding the location information from the calling PTT-enabled mobile terminal to a called PTT-enabled mobile terminal by the SIP server, and outputting the location information from the SIP server by the called PTT enabled mobile terminal.

The present invention also discloses a Push-To-Talk (PTT) service providing system including a calling PTT-enabled mobile terminal, a called PTT-enabled mobile terminal, and a Session Initiation Protocol (SIP) server to control a PTT call between the calling and called PTT-enabled mobile terminals, wherein the calling PTT-enabled mobile terminal transmits current location information thereof to the SIP server at initiation of a PTT call, the SIP server forwards the location information from the calling PTT-enabled mobile terminal to the called PTT-enabled mobile terminal, and the called PTT-enabled mobile terminal outputs the location information from the SIP server.

The present invention also discloses a Push-To-Talk (PTT) enabled mobile terminal for providing a PTT communication service, including a location information generator to generate current location information of the PTT-enabled mobile terminal, a Session Initiation Protocol (SIP) message composer to compose an SIP message containing the location information generated by the location information generator a location information extractor to extract location information from a received SIP message, and an information outputter to output the location information extracted by the location information extractor on a screen.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a configuration of a PTT-enabled mobile terminal according to an exemplary embodiment of the present invention.

FIG. 2 shows a configuration and operation of a PTT communication module in the PTT-enabled mobile terminal of FIG. 1.

FIG. 3 shows a configuration of a PTT-service providing system according to another exemplary embodiment of the present invention.

FIG. 4 is a sequence diagram showing an example operation of a sender location display method according to another exemplary embodiment of the present invention.

FIG. 5 is a sequence diagram showing another example operation of the method of FIG. 4.

FIG. 6 is a sequence diagram showing another example operation of the method of FIG. 4.

FIG. 7 is a flow chart showing a procedure performed by a calling PTT-enabled mobile terminal in the sender location display method of FIG. 4.

FIG. 8A and FIG. 8B are flow charts showing computation of the current location of the calling PTT-enabled mobile terminal in the procedure of FIG. 7.

FIG. 9 is a flow chart showing a procedure performed by a called PTT-enabled mobile terminal in the sender location display method of FIG. 4.

FIG. 10 shows location information inserted in a Session Initiation Protocol message for the method of FIG. 4.

FIG. 11A and FIG. 11B show screen representations of PTT call setting in a PTT-enabled mobile terminal.

FIG. 12A, FIG. 12B, FIGS. 12C, and 12D show screen representations of PTT call reception in the called PTT-enabled mobile terminal.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

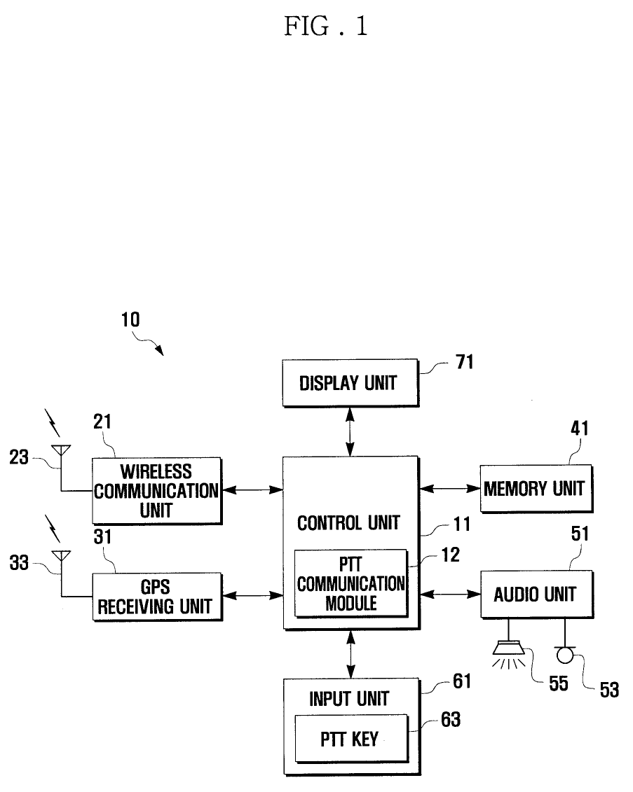

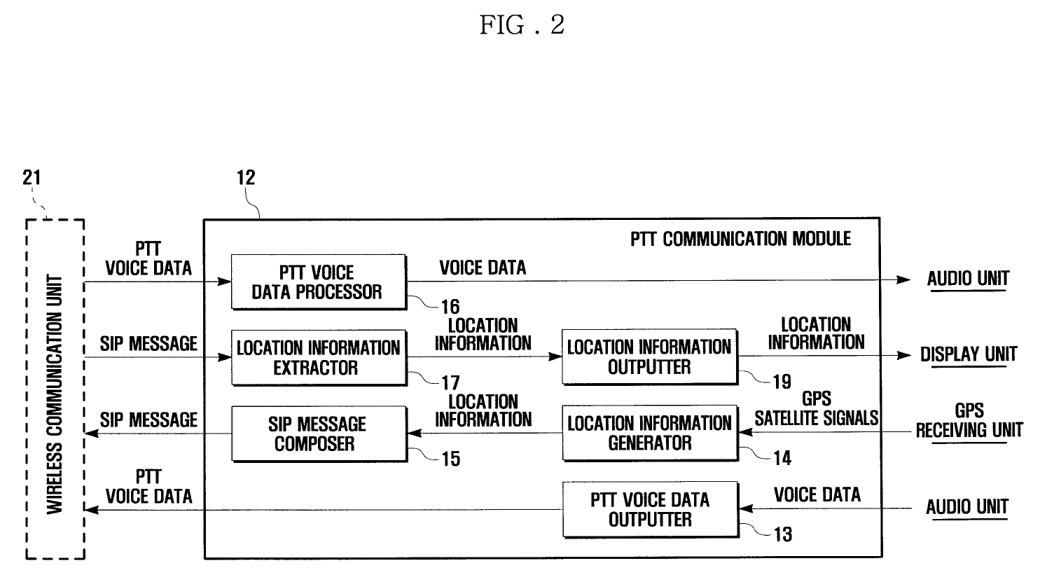

FIG. 1 shows a configuration of a PTT-enabled mobile terminal 10 according to an exemplary embodiment of the present invention, and FIG. 2 shows a configuration and operation of a PTT communication module 12 in the terminal of FIG. 1.

Referring to FIG. 1, the PTT-enabled mobile terminal 10 includes a control unit 11, a wireless communication unit 21, a global positioning system (GPS) receiving unit 31, a memory unit 41, an audio unit 51, an input unit 61, and a display unit 71.

The wireless communication unit 21 converts a radio frequency (RF) signal received through an antenna 23 into a digital signal and sends the digital signal to the control unit 11, and converts a signal from the control unit 11 into an RF signal and transmits the RF signal through the antenna 23. The wireless communication unit 21 may include an RF transmitter to upconvert the frequency of a signal to be transmitted and amplify the signal, and an RF receiver to low-noise amplify a received signal and downconvert the frequency of the received signal.

The GPS receiving unit 31 receives GPS signals through a GPS antenna 33 from at least three GPS satellites to compute the location of the PTT-enabled mobile terminal 10. The GPS receiving unit 31 may be implemented using a normal GPS receiver, and may be included in the control unit 11.

The memory unit 41 stores programs and associated data for PTT communication. PTT communication programs include programs to compose a Session Initiation Protocol (SIP) message, extract location information from an SIP message, and create and display location information. The memory unit 41 also stores programs and associated data to control the overall operation of the PTT-enabled mobile terminal 10, and various data resulting from execution of programs. The memory unit 41 may include various memory devices such as a flash memory.

The audio unit 51 converts an analog audio signal from a microphone 53 into a digital signal and sends the digital signal to the control unit 11, and it converts a digital audio signal from the control unit 11 into an analog signal and outputs the analog signal to a speaker 55. The audio unit 51 may include an audio coder/decoder (codec). The audio unit 51 may be included in the control unit 11.

The input unit 61 generates a command signal for the operation of the PTT-enabled mobile terminal 10. The input unit 61 includes a plurality of keys to input alphanumeric and special characters, a PTT key 63 to perform PTT communication, and other function keys. The input unit 61 may include various input means such as a key pad, a touch screen, and a touch pad.

The display unit 71 displays various information including operation status data and operation results of the PTT-enabled mobile terminal 10. The display unit 71 also displays windows for PTT communication and status data of ongoing PTT communication. The display unit 71 may include a liquid crystal display device or an organic light emitting diode display device.

The control unit 11 controls the overall operation of the PTT-enabled mobile terminal 10. The control unit 11 controls normal voice communication and PTT communication, and outputs information from the input unit 61 or operation status data to the display unit 71. The control unit 11 may include a coder to encode a signal to be transmitted and a modulator to modulate the coded signal, and a demodulator to demodulate a received signal and a decoder to decode the demodulated signal. The control unit 11 may be implemented using a QUALCOMM® Mobile Station Modem chipset or other microprocessors.

In particular, the control unit 11 includes a PTT communication module 12. As shown in FIG. 2, the PTT communication module 12 includes a PTT voice data outputter 13, a location information generator 14, an SIP message composer 15, a PTT voice data processor 16, a location information extractor 17, and a location information outputter 19.

The location information generator 14 operates, in response to the input of the PTT key 63, the GPS receiving unit 31 to generate location information of the PTT-enabled mobile terminal 10. The SIP message composer 15 composes an SIP message that contains location information created by the location information generator 14. The location information extractor 17 parses a received SIP message to extract location information of a calling PTT-enabled mobile terminal. The location information outputter 19 outputs location information extracted from a received SIP message to the display unit 71 for screen display.

The PTT voice data outputter 13 converts voice data from the audio unit 51 to PTT voice data during a PTT call. Speech data of a calling user is converted into PTT voice data and transmitted through the wireless communication unit 21. The PTT voice data processor 16 sends voice data received through the wireless communication unit 21 to the audio unit 51 for sound generation.

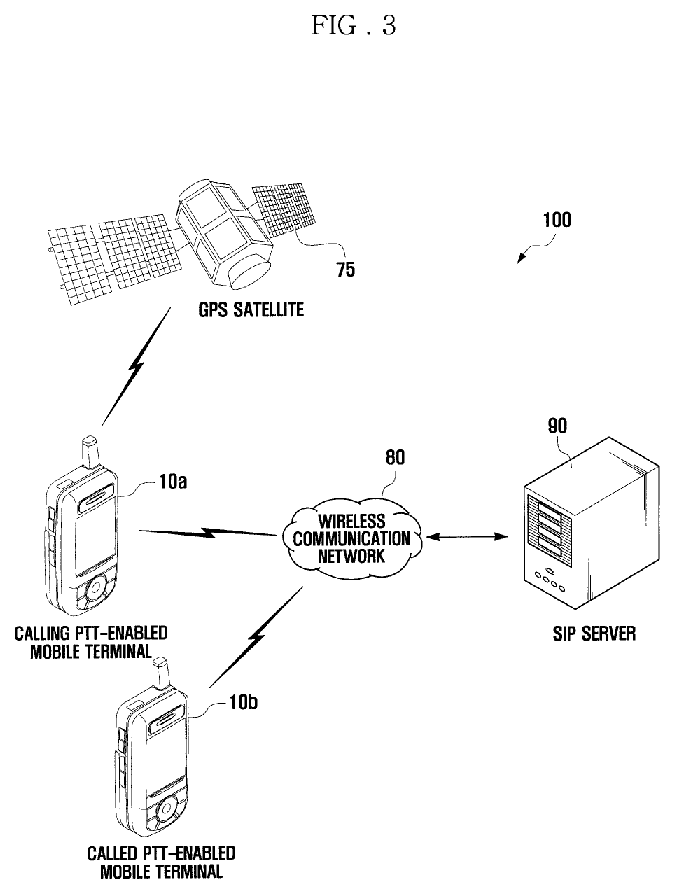

FIG. 3 shows a configuration of a PTT-service providing system 100 according to another exemplary embodiment of the present invention.

Referring to FIG. 3, the PTT-service providing system 100 includes a calling PTT-enabled mobile terminal 10a, a called PTT-enabled mobile terminal 10b, and an SIP server 90 to establish and control a PTT call between the calling and called PTT-enabled mobile terminals 10a and 10b. The calling and called PTT-enabled mobile terminals 10a and 10b are connected to the SIP server 90 through a wireless communication network 80 for PTT service reception and have a configuration identical to that of the PTT-enabled mobile terminal 10 of the first exemplary embodiment.

The wireless communication network 80 includes base stations and mobile switching centers (MSC). A base station communicates with a plurality of PTT-enabled mobile terminals within the service area and is connected to a mobile switching center through a base station controller (BSC). A mobile switching center is connected to the SIP server 90 through a data communication network.

The calling PTT-enabled mobile terminal 10a transmits speech data of the calling user and location information of itself to the called PTT-enabled mobile terminal 10b. The calling PTT-enabled mobile terminal 10a receives GPS signals from at least three GPS satellites 75 to compute the location of the calling PTT-enabled mobile terminal 10a. The location information can be transmitted as text data contained in a payload part of a SIP message. The called PTT-enabled mobile terminal 10b outputs received speech data through a speaker and displays received location information of the calling PTT-enabled mobile terminal 10a on a screen.

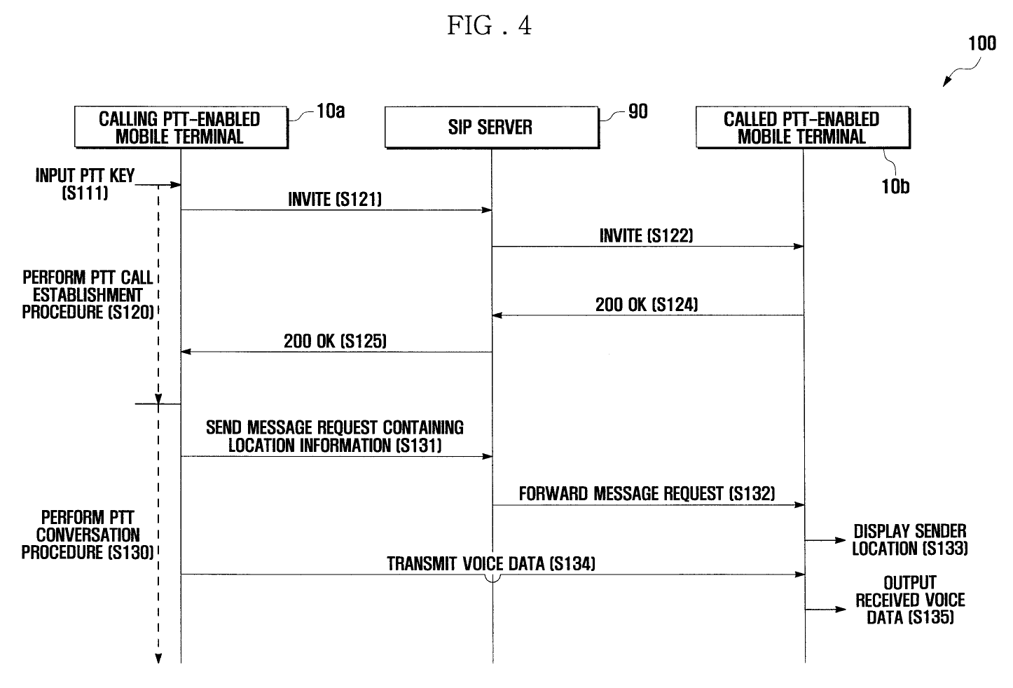

FIG. 4 is a sequence diagram showing an example operation of a sender location display method according to another exemplary embodiment of the present invention.

Referring to FIG. 4, the sender location display method includes a PTT call establishment procedure (S120) and a PTT conversation procedure (S130). SIP is used as a signaling protocol for PTT call processing. The SIP server 90 relays SIP messages between the calling and called PTT-enabled mobile terminals 10a and 10b.

A PTT communication service is initiated by inputting the PTT key 63. When the PTT key 63 is pressed by the calling user for PTT communication (S111), the calling PTT-enabled mobile terminal 10a initiates PTT call establishment by transmitting an INVITE request message for PTT conversation through the wireless communication network 80 to the SIP server 90 (S121).

Before trying PTT communication, the calling user can use the calling PTT-enabled mobile terminal 10a to access the SIP server 90 through the wireless communication network 80, and to select one of registered PTT service subscribers as the called user. The wireless communication network 80 may include a base station serving the calling PTT-enabled mobile terminal 10a (referred to as the calling side base station), a mobile switching center, and a base station serving the called PTT-enabled mobile terminal 10b (referred to as the called side base station).

The INVITE request message for PTT conversation may be transmitted as a short data burst (SDB) message. The INVITE request message may include a calling party identifier and a called party identifier. Although not shown in FIG. 4, after transmission of the INVITE request message, the calling PTT-enabled mobile terminal 10a may perform service option negotiation with the calling side base station to establish a traffic channel. During service option negotiation, parameters for a path from physical to application layers, including a point-to-point link, may be adjusted for a PTT session.

Upon reception of the INVITE request message, the SIP server 90 identifies the calling party identifier in the INVITE request message and forwards the INVITE request message through the wireless communication network 80 to the called PTT-enabled mobile terminal 10b (S122).

During step S122, the SIP server forwards the INVITE request message to the called side base station, which then periodically sends a paging signal to the called PTT-enabled mobile terminal 10b. In response to the paging signal, the called PTT-enabled mobile terminal 10b sends a paging response signal to the called side base station. After paging, the called side base station transmits the INVITE request message as an SDB message to the called PTT-enabled mobile terminal 10b.

Upon reception of the INVITE request message for PTT conversation, the called PTT-enabled mobile terminal 10b informs the called user of the received INVITE request message using an alert sound or alert message.

In return, the called PTT-enabled mobile terminal 10b transmits a 200 OK response message through the wireless communication network 80 to the SIP server 90 (S124). The called PTT-enabled mobile terminal 10b also performs service option negotiation with the called side base station to establish a traffic channel.

Upon reception of the 200 OK response message, the SIP server 90 forwards the 200 OK response message to the calling PTT-enabled mobile terminal 10a (S125). When the calling PTT-enabled mobile terminal 10a receives the 200 OK response message for request acceptance, it establishes a traffic channel and informs the calling user of acceptance of the PTT conversation request through the display unit 71.

After PTT call establishment, the calling and called PTT-enabled mobile terminals 10a and 10b start the PTT conversation procedure using the Real-time Transport Protocol (RTP) for real-time transmission of voice data (S130). During the PTT session, the calling PTT-enabled mobile terminal 10a sends voice data to the called PTT-enabled mobile terminal 10b (S134), which then outputs the received voice data (S135). The calling PTT-enabled mobile terminal 10a may buffer speech data input before start of the PTT session, and sends the buffered speech data to the called PTT-enabled mobile terminal 10b after start of the PTT session.

In addition, at the start of the PTT session, the calling PTT-enabled mobile terminal 10a sends a MESSAGE request message containing location information to the SIP server 90 using the SIP ‘message’ method (S131). The SIP server 90 then forwards the MESSAGE request message to the called PTT-enabled mobile terminal 10b (S132).

Upon reception of the MESSAGE request message containing location information, the called PTT-enabled mobile terminal 10b extracts location information from the received MESSAGE request message, and displays the extracted location information as a sender location through the display unit 71 (S133). The called PTT-enabled mobile terminal 10b parses a received MESSAGE request message to determine whether location information is present in the MESSAGE request message. If location information is present in the MESSAGE request message, the called PTT-enabled mobile terminal 10b displays the location information as a sender location. Hence, the called user can identify the location of the calling user during PTT conversation.

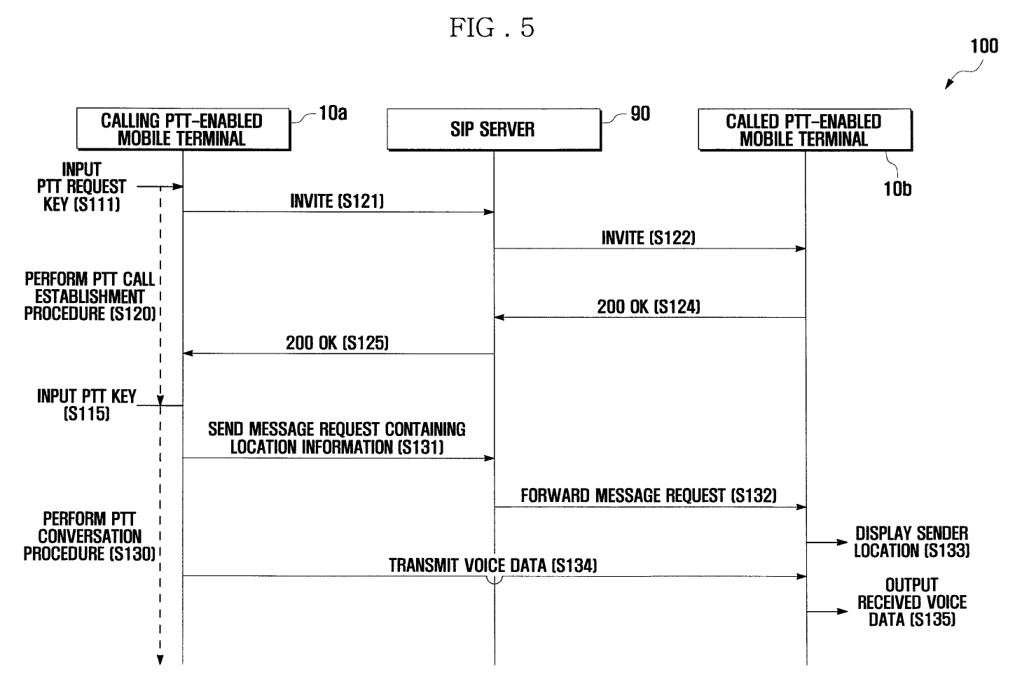

FIG. 5 is a sequence diagram showing another example operation of the sender location display method of FIG. 4.

The operation described in FIG. 5 is different from the operation described in FIG. 4 in that a PTT call establishment procedure (S120) is initiated first in response to input of a PTT request key, and then the PTT key 63 is input and a PTT conversation procedure (S130) is started.

At the start of the PTT session, the calling PTT-enabled mobile terminal 10a sends a MESSAGE request message containing location information to the SIP server 90 using the SIP ‘message’ method (S131). The SIP server 90 then forwards the MESSAGE request message to the called PTT-enabled mobile terminal 10b (S132). The called PTT-enabled mobile terminal 10b receives the MESSAGE request message, extracts location information from the received MESSAGE request message, and displays the extracted location information as a sender location through the display unit 71 (S133). The other steps shown in FIG. 5 are the same as the corresponding steps in FIG. 4.

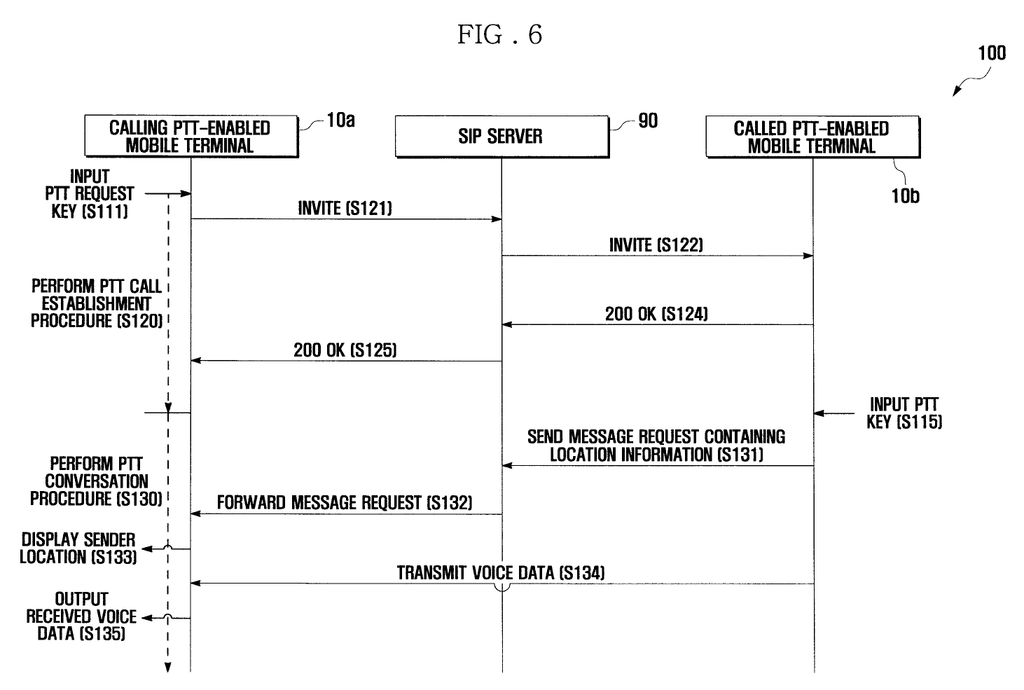

FIG. 6 is a sequence diagram showing another example operation of the sender location display method of FIG. 4.

In the operation described in FIG. 6, while a PTT call establishment procedure (S120) is initiated by the calling PTT-enabled mobile terminal 10a, a PTT conversation procedure (S130) is started by the called PTT-enabled mobile terminal 10b.

When the PTT request key is input from the calling user for PTT communication (S111), the calling PTT-enabled mobile terminal 10a initiates PTT call establishment.

When the PTT key 63 of the called PTT-enabled mobile terminal 10b is input in the PTT session after PTT call establishment (S115), the called PTT-enabled mobile terminal 10b sends a MESSAGE request message containing location information to the SIP server 90 using the SIP ‘message’ method (S131). The SIP server 90 then forwards the MESSAGE request message to the calling PTT-enabled mobile terminal 10a (S132). The calling PTT-enabled mobile terminal 10a receives the MESSAGE request message, extracts location information from the received MESSAGE request message, and displays the extracted location information as a sender location through the display unit 71 (S133). Other steps are the same as corresponding steps in FIG. 4.

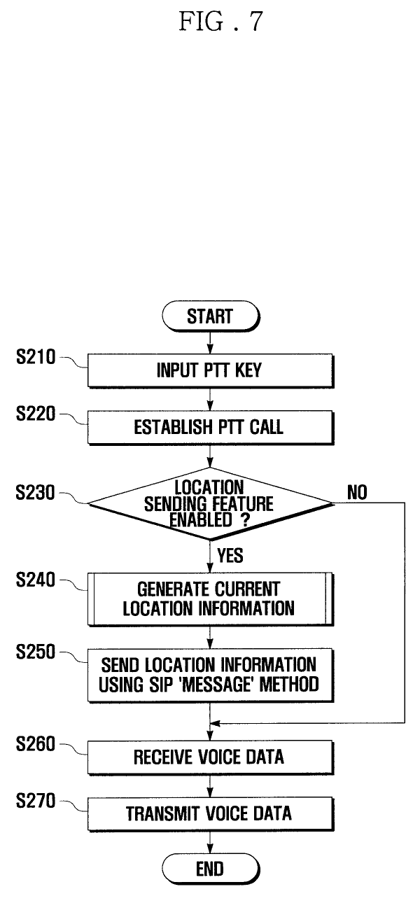

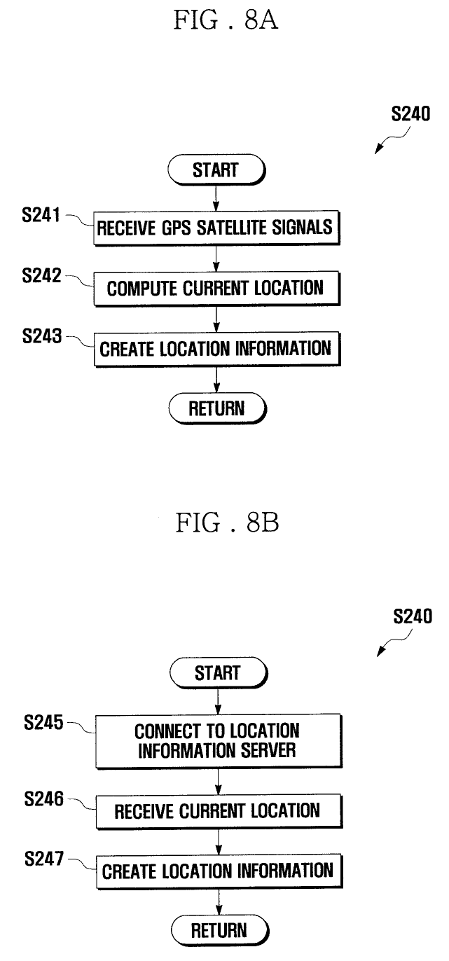

FIG. 7 is a flow chart showing a procedure performed by the calling PTT-enabled mobile terminal in the sender location display method of FIG. 4. FIG. 8A and FIG. 8B are flow charts showing computation of the current location of the calling PTT-enabled mobile terminal in the procedure of FIG. 7.

Referring to FIG. 7, when the PTT key 63 of the input unit 61 is pressed by the calling user for PTT communication (S210), the control unit 11 of the calling PTT-enabled mobile terminal 10a initiates PTT call establishment (S220). At step S220, the PTT communication module 12 transmits an INVITE request message for PTT conversation through the wireless communication unit 21 to the SIP server 90, which then forwards the INVITE request message to the called PTT-enabled mobile terminal 10b. In return, the called PTT-enabled mobile terminal 10b transmits a 200 OK response message to the SIP server 90, which then forwards the 200 OK response message to the calling PTT-enabled mobile terminal 10a. When the calling PTT-enabled mobile terminal 10a receives the 200 OK response message through the wireless communication unit 21, the requested PTT call is established.

After PTT call establishment, the control unit 11 checks whether a location sending feature is enabled (S230). If the location sending feature is enabled, the control unit 11 generates the current location information of the calling PTT-enabled mobile terminal 10a (S240). Location information can be generated using a Global Positioning System (GPS) or a location information server. The location information may include latitude and longitude.

Referring to FIG. 8A, generation of location information using GPS is described as follows. The control unit 11 of the calling PTT-enabled mobile terminal 10a controls the GPS receiving unit 31 to receive GPS signals from at least three GPS satellites (S241), to compute the current location of the calling PTT-enabled mobile terminal 10a using the received GPS signals through the location information generator 14 (S242), and to create location information (S243).

Referring to FIG. 8B, generation of location information using a location information server is described as follows. The control unit 11 of the calling PTT-enabled mobile terminal 10a controls the wireless communication unit 21 to connect to the location information server (not shown) through a serving base station (S245), to receive the current location data of the calling PTT-enabled mobile terminal 10a (S246), and then to create location information (S247).

Referring back to FIG. 7, after generation of the location information, the control unit 11 sends a MESSAGE request message containing the generated location information via the SIP server 90 to the called PTT-enabled mobile terminal 10b using the SIP ‘message’ method (S250). At step S250, the control unit 11 converts the location information from the location information generator 14 into text data, composes a SIP MESSAGE request message containing the text data, and transmits the SIP MESSAGE request message through the wireless communication unit 21.

During the PTT session, independently of location information transmission, the control unit 11 controls the PTT voice data generator 13 to convert speech data from the audio unit 51 into PTT voice data (S260), and transmits the PTT voice data through the wireless communication unit 21 (S270).

If the location sending feature is not enabled at step S230, the control unit 11 performs steps S260 and S270 for PTT voice data transmission without location information transmission.

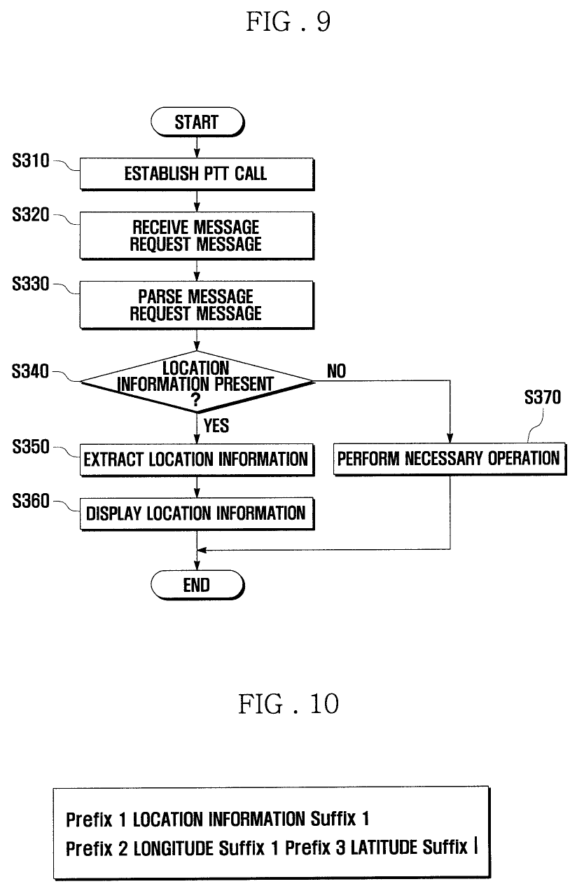

FIG. 9 is a flow chart showing a procedure performed by the called PTT-enabled mobile terminal 10b in the sender location display method of FIG. 4.

Referring to FIG. 9, in response to reception of an INVITE request message for PTT conversation through the wireless communication unit 21, the control unit 11 of the called PTT-enabled mobile terminal 10b transmits a 200 OK response message to the calling PTT-enabled mobile terminal 10a to thereby establish a PTT call (S310).

After PTT call establishment, the control unit 11 receives a MESSAGE request message through the wireless communication unit 21 (S320) and parses the received MESSAGE request message (S330).

The control unit 11 checks whether location information is present in the received MESSAGE request message (S340). If location information is present in the received MESSAGE request message, the control unit 11 extracts location information from the MESSAGE request message (S350).

The control unit 11 displays the extracted location information through the display unit 71 (S360). The extracted location information is displayed, under the control of the control unit 11, according to display characteristics of the called PTT-enabled mobile terminal 10b using latitude and longitude, geographical text strings, maps, and the like.

If location information is not present in the received MESSAGE request message at step S340, the control unit 11 performs a necessary operation for processing the received MESSAGE request message (S370).

During the PTT session, independently of location information processing, the control unit 11 of the called PTT-enabled mobile terminal 10b receives PTT voice data from the calling PTT-enabled mobile terminal 10a through the wireless communication unit 21, converts the received PTT voice data into voice data suitable for reproduction, and outputs the voice data to the audio unit 51. The audio unit 51 reproduces the voice data through the speaker 55, under the control of the control unit 11.

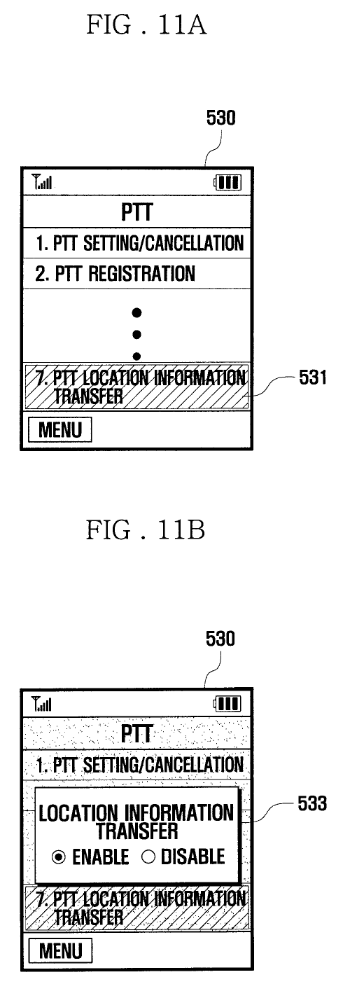

FIG. 10 shows location information inserted in a SIP request message for the method of FIG. 4.

Location information that can be transmitted by the calling PTT-enabled mobile terminal 10a and received by the called PTT-enabled mobile terminal 10b is text-coded in an SIP message, as shown in FIG. 10. Text-coded location information can be composed of a longitude and latitude. Text-coded location information can be distinguished from other text strings using tags. For example, Prefix1, Prefix2, Prefix3, and Suffix1 in FIG. 10 are tags. Prefix tags are different from each other and suffix tags may be the same. A prefix tag identifies accompanying data. By help of tags, the called PTT-enabled mobile terminal 10b can extract location information from an SIP message.

Tags may be characters or symbols available in a keypad or on a screen. For example, a tag is a “*”, “#”, “/”, “@”, space, “-”, “?”, “<”, or the like. A tag may also be composed of a single character, multiple characters, or a combination of characters.

For example, a longitude of 132.123 and latitude of 37.123 can be text-coded as “//location information??<<:132.123??##:37.123??” in a SIP message. The tag ‘//’ refers to the beginning of location information, the tag ‘<<’ refers to the beginning of a longitude, and the tag ‘##’ refers to the beginning of a latitude. The tag ‘??’ acts as a separator between text fields.

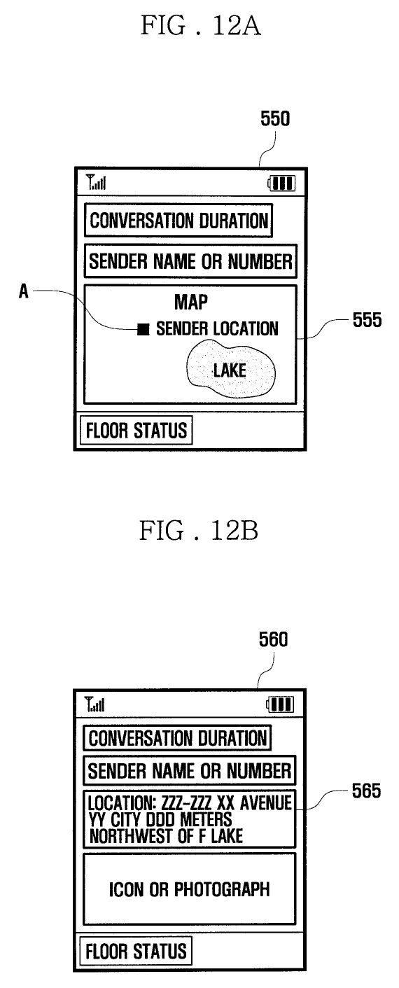

FIG. 11A and FIG. 11B show screen representations of PTT call setting in the calling mobile terminal.

The PTT-enabled mobile terminal 10 provides a PTT setting window 530 as in FIG. 11A. When an item of PTT location information transfer 531 is selected, a popup window 533 may be displayed as in FIG. 11B. The popup window 533 displays ‘enable’ and ‘disable’ options. If the ‘enable’ option is selected, the location sending feature is enabled, and current location information is transmitted using an SIP message together with voice data whenever the PTT key 63 is input during a PTT session. If the ‘disable’ option is selected, voice data is transmitted without location information transmission.

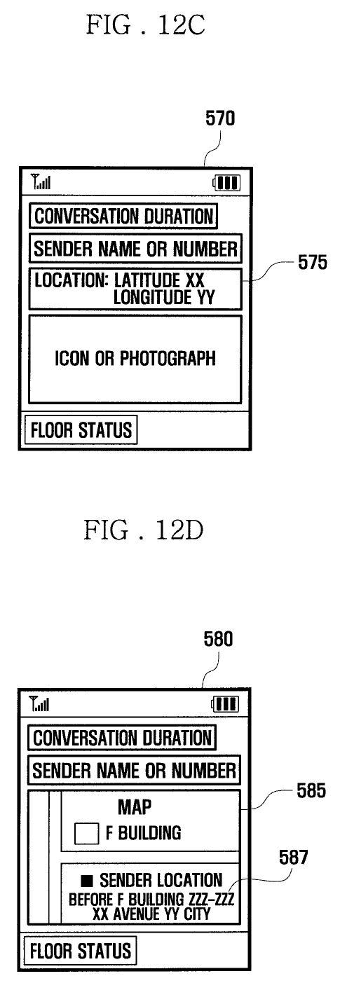

FIG. 12A, FIG. 12B, FIG. 12C, and FIG. 12D show screen representations of PTT call reception in the called mobile terminal.

As shown in FIG. 12A, the sender location may be displayed using a map 555 in a PTT conversation screen 550 of the called PTT-enabled mobile terminal 10b. The sender location is indicated by a mark A on the map 555. If the location information from the calling PTT-enabled mobile terminal 10a is composed of a latitude and longitude, the control unit 11 of the called PTT-enabled mobile terminal 10b retrieves a map covering the latitude and longitude from the memory unit 41, and displays the retrieved map on a reduced scale with a mark indicating the sender location corresponding to the latitude and longitude. Hence, the called user can identify the location of the calling user on a displayed map during PTT conversation.

As shown in FIG. 12B, the sender location can be displayed using a geographical text string 565 in a PTT conversation screen 560. If the location information from the calling PTT-enabled mobile terminal 10a is composed of a latitude and longitude, the control unit 11 of the called PTT-enabled mobile terminal 10b retrieves a geographical text string describing the latitude and longitude from the memory unit 41 and displays the retrieved geographical text string.

As shown in FIG. 12C, the sender location may be displayed using a pair of a latitude and longitude coordinates 575 in a PTT conversation screen 570. As shown in FIG. 12D, the sender location may be displayed using a mark 585 on a map and a geographical text string in a PTT conversation screen 580.

As apparent from the above description, the present invention provides a PTT-enabled mobile terminal, a PTT-service providing system, and a sender location display method, wherein the location of a calling PTT-enabled mobile terminal is transmitted in real-time to a called PTT-enabled mobile terminal with a touch of the PTT key. Thereby, a called user or group members in a group call may identify the location of the PTT sender.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A sender location display method for a Push-To-Talk (PTT) service providing system, the system comprising a calling PTT-enabled mobile terminal, a called PTT-enabled mobile terminal, and a Session Initiation Protocol (SIP) server for controlling a PTT call between the calling and called PTT-enabled mobile terminals, the method comprising:
transmitting current location information of the calling PTT-enabled mobile terminal to the SIP server at initiation of a PTT call by the calling PTT-enabled mobile terminal;
forwarding the location information from the calling PTT-enabled mobile terminal to the called PTT-enabled mobile terminal by the SIP server; and
outputting the location information from the SIP server by the called PTT-enabled mobile terminal.

2. The sender location display method of claim 1, wherein transmitting current location information comprises:
generating current location information of the calling PTT-enabled mobile terminal by the calling PTT-enabled mobile terminal;
composing an SIP message comprising the generated location information; and
transmitting the composed SIP message to the SIP server.

3. The sender location display method of claim 2, wherein generating current location information comprises receiving signals from satellites of a Global Positioning System to compute a current location.

4. The sender location display method of claim 2, wherein generating current location information comprises receiving location information from a location information server connected through a wireless communication network.

5. The sender location display method of claim 2, wherein the generated location information is inserted into the SIP message together with tags.

6. The sender location display method of claim 2, wherein the generated location information is text-coded and contained in a payload part of the SIP message.

7. The sender location display method of claim 2, wherein the generated location information includes a longitude coordinate and a latitude coordinate.

8. The sender location display method of claim 2, wherein outputting the location information comprises:
receiving an SIP message from the SIP server by the called PTT-enabled mobile terminal;
extracting location information from the received SIP message; and
displaying the extracted location information on a screen.

9. The sender location display method of claim 8, wherein displaying the extracted location information comprises displaying the extracted location information in a PTT conversation window.

10. The sender location display method of claim 9, wherein displaying the extracted location information comprises displaying a map with a mark indicating a location corresponding to the extracted location information.

11. The sender location display method of claim 10, wherein displaying the extracted location information comprises displaying a geographical text string corresponding to the extracted location information.

12. A Push-To-Talk (PTT) service providing system, comprising:
a calling PTT-enabled mobile terminal;
a called PTT-enabled mobile terminal; and
a Session Initiation Protocol (SIP) server to control a PTT call between the calling PTT-enabled mobile terminal and the called PTT-enabled mobile terminal,
wherein the calling PTT-enabled mobile terminal transmits current location information thereof to the SIP server at initiation of the PTT call, the SIP server forwards the location information from the calling PTT-enabled mobile terminal to the called PTT-enabled mobile terminal, and the called PTT-enabled mobile terminal outputs the location information from the SIP server.

13. The PTT service providing system of claim 12, wherein the calling PTT-enabled mobile terminal comprises:
a location information generator to generate the current location information of the calling PTT-enabled mobile terminal; and
a SIP message composer to compose an SIP message comprising the generated location information.

14. The PTT service providing system of claim 13, wherein the calling PTT-enabled mobile terminal further comprises a Global Positioning System (GPS) receiving unit to receive GPS satellite signals.

15. The PTT service providing system of claim 14, wherein the location information generator generates location information using the GPS satellite signals received through the GPS receiving unit.

16. The PTT service providing system of claim 14, wherein the location information generator receives location information from a location information server connected through a wireless communication network.

17. The PTT service providing system of claim 14, wherein the called PTT-enabled mobile terminal comprises:
a location information extractor to extract the location information from the received SIP message; and
a location information outputter to output the extracted location information.

18. The PTT service providing system of claim 17, wherein the location information outputter displays a map with a mark indicating a location corresponding to the extracted location information.

19. The PTT service providing system of claim 17, wherein the location information outputter displays a geographical text string corresponding to the extracted location information.

20. A Push-To-Talk (PTT) enabled mobile terminal for providing a PTT communication service, comprising:
a location information generator to generate current location information of the PTT-enabled mobile terminal;
a Session Initiation Protocol (SIP) message composer to compose an SIP message containing the location information generated by the location information generator;
a location information extractor to extract location information from a received SIP message; and
a location information outputter to output the location information extracted by the location information extractor to be displayed.
